(19) United States
(12) Patent Application Publication
(10) Pub. No.: US 2008/0141247 A1
(43) Pub. Date: Jun. 12, 2008

(54) System and method for information management

(76) Inventor: Thiagarajan Saravanan, Westborough, MA (US)

Correspondence Address: THIAGARAJAN SARAVANAN, 4 OLDE STONEBRIDGE PATH, WESTBOROUGH, MA, 01581, US

(21) Appl. No.: 11/008,056

(22) Filed: Dec. 9, 2004

(51) Int. Cl. G06F 9/46

(52) U.S. Cl. 718/100

(57) ABSTRACT

The vast majority of today's busy families with computers, personal digital assistants (PDAs), and cell phones (all modern computing devices classified generally as computers), still use wall calendars, sticky notes, and kitchen message boards to coordinate their everyday activities. The complexity of family schedules and household information, ease of use, ease of access, and portability have remained powerful barriers to adoption of electronic solutions. This invention features computer-based input methods for use in group calendaring such that in the shortest possible amount of time, and with the least amount of effort, notations can be made of one or more events or tasks pertaining to one or more people using computers in one or more computer networks.

### BACKGROUND OF THE INVENTION

This invention relates to using a computer for personal and group information management and communication.

The vast majority of today's busy families with computers, personal digital assistants (PDAs), and cell phones (all modern computing devices classified generally as computers), still use wall calendars, sticky notes, and kitchen message boards to coordinate their everyday activities. The complexity of family schedules and household information, ease of use, ease of access, and portability have remained powerful barriers to adoption of electronic solutions.

Numerous solutions have been attempted to induce families to adopt computing devices for the task, with limited success. In the Oct. 15, 2003 edition of the Wall Street Journal well-known technology columnist Walt Mossberg wrote: “Today, busy families need more than simple wall calendars to keep their lives organized. With both parents often working and children's lives packed with activities, the problem of meshing everyone's schedules has become acute. Some families have resorted to wring schedules on white boards, assigning different colored markers to each person. Others paper their refrigerators with various print-outs and calendars for scout troop meetings, music lessons and game schedules. But these paper reminders are hard to sync with work calendars that are often kept on computers.”

“For years, technology companies have made sporadic attempts at products that coordinate family schedules electronically. But the solutions generally required too much work and involved too much complexity to be worth the benefits they offered.”

Walt Mossberg wrote this as part of a review of a hardware product called the Home Organizer from a company called Simpliciti, which he also rejected as a solution.

Zanthus [1,2], a reputable market research firm employed by the Internet Home Alliance, a consortium of companies such as IBM, Microsoft, HP, and Proctor & Gamble, offers a review of the state-of-the-art in family calendaring and concludes that the lack of good universal family calendaring solution has hurt the adoption of digital technologies in the home.

The key problem with existing solutions, is the so-called “entry problem”. The wall calendar and day planner win out over computer-based solutions primarily because of the cost, in time and effort, associated with making entries in or consulting a computer-based calendar, whether it is a desktop computer or a hand-held one. The average user takes between 15 and 45 seconds to successfully make an entry on a computer-based calendar, with an average of about 15 “touchpoints” in the form on which the entry is made (see FIG. 3). A touchpoint is a computer form element such as a text box, drop-down, checkbox, radio button, or command button. A number of studies point to the fact that any activity that takes greater than 8 seconds on a regular basis will be avoided by most users. Even though a computer-based form for calendar entry may be considered to be simple, having been in vogue for more than a decade, and familiar to most computer users, the failure to meet this usability threshold has relegated it to a state where only the most savvy computer users ever manage their everyday routines using computer-based calendars. Even the inconvenience of having to transcribe calendar entries from multiple calendars into the common calendar periodically isn't enough to push people into using computer-based tools.

Some companies have tried to solve this problem differently. Xerox [3] has invented a solution to automatically scan various documents such as those found on the web or those that schools send home with students for calendaring information to construct a database of calendaring information that could then be automatically fed into computer-based calendars. Problems with this approach include the non-uniform availability of electronically-available calendaring information, the human cost to verify the accuracy of the automatically-collected information and apply corrections, and so on.

A great many user considerations went into the building of our invention:
Ease of setup & organization—How easy is it to set up the information pertaining to the daily activities of multiple individuals? How easy it is to modify and maintain this information? How natural is the user interface? I hate dialog boxes. I'm used to making lists for everything—can I do that with your system?
Ease of ongoing maintenance—Is the effort of keeping it up-to-date going to be worth the value I get back from it? Do I have to keep “feeding” it?
Ease of access—How quickly can I get to the functionality I need? Can I use it anywhere? (At home, at work, at soccer practice, through my cell phone, TV, etc.)
Ease for routine use—How quickly can I input and retrieve information? Will it work with kids and seniors? Will it work for technophobes? What level of dexterity is needed for casual use? (In other words, can you beat finding a piece of paper, a pencil, and jotting down something?)
Scope and completeness of solution—Most electronic calendars are not suited to dealing with a large number of entries pertaining to daily recurring activities that must be tracked. In households with children and some seniors, this is a key requirement. Can I do everything I need with respect to household information management with this solution? How rich is the functionality? In what ways can this product improve my life?
Connectedness of information—How smart is the system in understanding the connections between the different aspects (people, places, things) of my life? How much does the system automatically do for me based on this understanding?
Form factor and interaction modalities-How robust is the system for daily use? Does it have a small screen and a tiny keyboard as the only means of interaction? Does it support voice interaction?
Transcription and corrections for multiple users—How easily can data for multiple users be seen through a single user view? How easy will it be to change the information? How will change notification work?
Self-sufficiency of system—What external dependencies does the system have? Will it work well by itself?
Interoperability with other systems—How well does it work with other software such as Microsoft Outlook, web calendars? Will it work with what I already have, like PDAs and cell phones?
Cost of acquisition—How much does it cost? What kind of system or hardware do I need?
Security & Privacy—Where will the data be stored? Who will have access to it? Is this spyware? How can I keep some information secret from other users?

### BRIEF SUMMARY OF THE INVENTION

In general in one aspect, the invention features a computer-based method for use in group calendaring. According to the method, the computer allows the input of calendaring information in a shorthand such that it is possible to notate an event pertaining to one or more individuals, whether it is a one-time event or an event that recurs in one of several different ways, in the shortest possible amount of time, and with the least amount of effort.

In general in another aspect, the invention features a computer-based method for creating a list of related or unrelated group calendar entries in a shorthand such that it is possible to create a complex set of schedules involving one or more events and one or more people in the shortest possible amount of time and with the least amount of effort.

In general in another aspect, the invention features a computer-based method for sharing and importing one or more calendar entries with the least amount of effort such that individuals in a community can seamlessly share such information amongst themselves in a highly localized manner heretofore unavailable.

In general in another aspect the invention features a computer-based method of interacting with the user that allows for quicker entry, quicker access to, and quicker modification of frequently used information.

In general in another aspect, the invention features a computer-based method of interacting with the user that allows one fixed part of the application to be used to input a variety of information such that, instead of selecting various menus, forms, or applications, the user always uses that part of the application to perform various functions, such as making a calendar entry, creating a task, sending an email or cell phone text message, keeping a journal and so on. The user can always visit a certain part of the application and perform the required task using one input field and the same shorthand notation used elsewhere in the application.

In general in another aspect the invention features a computer-based method of bringing lifestyle information such as news, weather, shopping, etc., automatically to the user based on their profile, without compromising the user's privacy.

In general in another aspect, the invention features a computer-based method of controlling the notification of event additions and reminders such that a group member can choose to receive notification or not on a variety of devices and channels, such as email, cell phones, and instant messengers.

Implementations of the invention may include one or more of the following features:
1) A Group Monthly Planner user interface
2) A Group Daily Planner user interface
3) A Group Activity Planner user interface
4) A Group List Planner user interface
5) A Group Memo Pad user interface
6) A Photo Player user interface
7) A Web Player user interface
8) An Address Book user interface
9) One or more viewports capable of delivering a variety of information
10) A server and object database on premises in a local area wired or wireless network
11) A common web server and database at http//mediabee.com
12) A Jabber (instant messaging) server to detect presence and provide directory information for instant message-based communication for remote access of premises equipment and data.

Among the advantages of the invention are one or more of the following. A user can enter or review group scheduling information with the same ease-of-use and flexibility that wall calendars and day planners offer. Each member of the group can view his or her information separately or together with those of other members. Each member can enter information on his or her own behalf or on someone else's behalf with the same ease of use and speed, without requiring a separate login process. In general, the invention makes managing group communication, whether in a family situation or in a small workgroup situation, a lot easier than other available computer-based solutions, and comparable in user experience to wall calendars.

### BRIEF DESCRIPTION OF THE DRAWINGS

FIG. 1 is a block diagram that shows the scope and architecture of the invention.

FIG. 2 is a block diagram of the application.

FIG. 3 is a screenshot of the main user interface of the application.

FIG. 4 is a screenshot that shows another aspect (the List Planner) of the application.

FIG. 5 shows the calendar entry creation user interface for the Yahoo web calendar, to contrast it with the calendar entry interface of FIG. 3.

FIG. 6 shows the Day Planner user interface.

FIG. 7 shows the Activity Planner user interface.

FIG. 8 shows the Memo Pad user interface.

FIG. 9 shows the Photo Player user interface.

FIG. 10 shows the Web Player user interface.

### DETAILED DESCRIPTION OF THE INVENTION

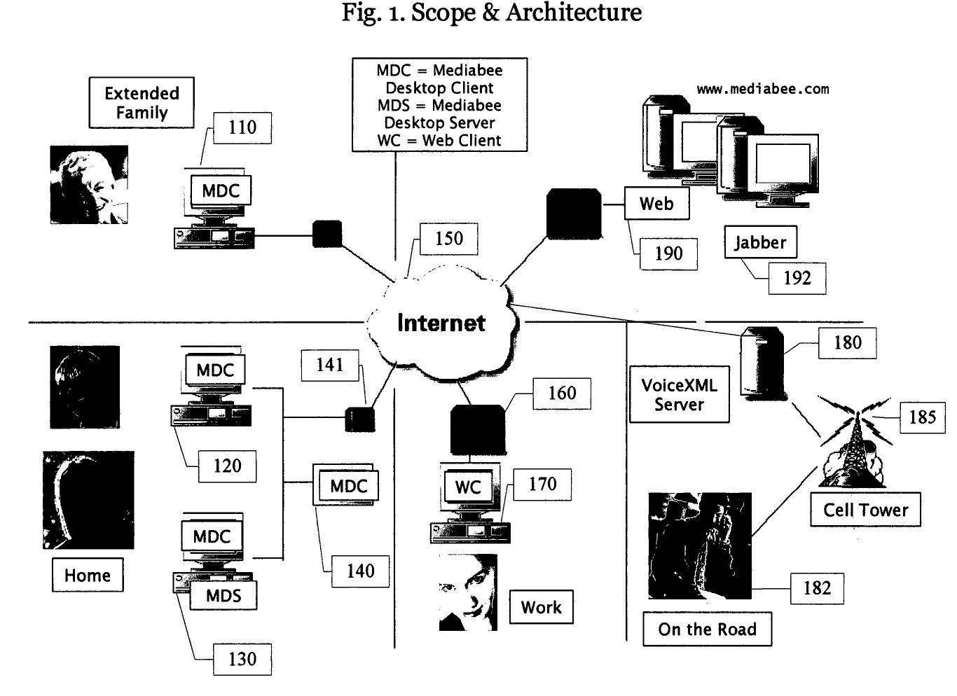

In the computer network diagram of FIG. 1, which shows the domain and scope of the invention, computer system 130 is connected to a home network that is secured by a network router/firewall 141, to computer system 120, and to a wireless computer display 140. This home network (labeled Home) is connected to the Internet cloud 150. Also connected to the Internet cloud is computer system 110 belonging to Extended Family. Work computer 170 is connected to firewall 160, which is also connected to the Internet cloud 150. Computer servers 190, running Web, Jabber, and Resin servers, are also connected to the Internet cloud 150. VoiceXML server 180 is also connected to the Internet cloud 150.

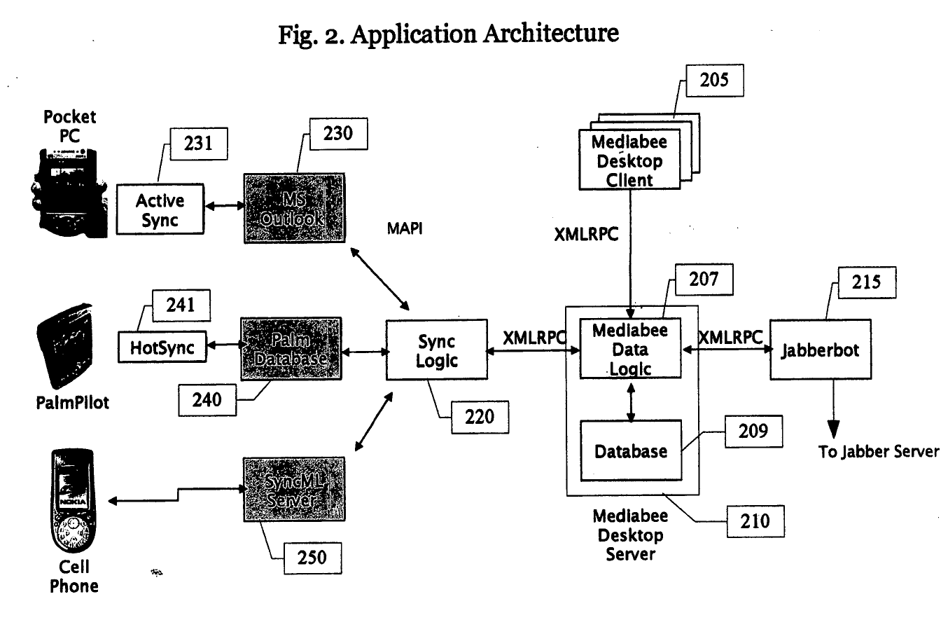

Computer system 130 is running two software components, labeled as Mediabee Desktop Client (MDC) and Mediabee Desktop Server (MDS), which components are also shown in FIG. 2.

In the application block diagram of FIG. 2, Mediabee Client 205 is a separate program that communicates with Mediabee Desktop Server 210 using the extended markup language (XML) remote procedure call (RPC) protocol Mediabee Desktop Server 210 is comprised of two logical pieces, Mediabee Data Logic 207 and Database 209. Another component 215, Jabberbot, communicates to Mediabee Desktop Server 210 through XML RPC also. Jabberbot communicates with a Jabber server using the Jabber protocol Sync Logic, 220, communicates with Mediabee Desktop Server through XML RPC. Sync Logic 220 has components that allow it to synchronize data from Database 209 with popular mobile devices and with popular calendaring programs like Microsoft Outlook.

All the components shown in FIG. 2 could operate independently on separate computers and processes or together on one computer system.

Mediabee Desktop Client is a browser-based application, written primarily in HTML and Javascript and “wrapped” in a native shell application (for example, a Windows EXE file) to provide better control and security. Other kinds of Mediabee clients are possible. For example, the Mediabee Web Client is a pure web client in the sense that it only uses web-native HTML and Javascript. Mediabee Desktop Server is written in Python. The database used is an object-oriented database. Zope Object Database, or ZODB, is the one we used.

FIG. 1 shows one possible implementation of the Mediabee network, with system 130 running in the Home network holding all the information pertaining to scheduling and communication in the household. System 130 could be an ordinary desktop computer, a home gateway computer, a standalone computer, or even a home entertainment center running the Mediabee Desktop Server application. It may or may not be running the Mediabee Desktop Client application. Such a computer could run any computer operating system such as Microsoft® Windows XP or some flavor of Linux.

Usage scenarios for the Mediabee application in a network as shown in FIG. 1 could be as follows:
Scenario 1: A complete standalone system where all the data resides on one computer, with no network interaction required. System 130 is a standalone system with no home network present. The Mediabee Desktop Server and Mediabee Desktop Client are both running on the same system. The Mediabee Desktop Server has no visible user interface to the end user. All interaction with the end users happens through one of the user interfaces. The end user primarily interacts with the application using the Mediabee Desktop Client.
Scenario 2: The same system as in Scenario 1, with the addition of a home network and an additional desktop computer 120 running the Mediabee Desktop Client application.
Scenario 3: The same system as in Scenario 2, with the addition of a wireless flat panel 140 running the Mediabee Desktop Client.
Scenario 4: The system of Scenario 3 connected to the Internet cloud 150 to Mediabee servers 190 and to a work computer network running the Mediabee Web Client (WC) 170. The Mediabee Web Client is simply a pure browser-based application that can run in Microsoft Internet Explorer or Mozilla Firefox
Scenario 5: The system of Scenario 4 connected to an extended family member's or friend's home computer 110 through the Internet cloud 150.
Scenario 6: The system of Scenario 5 connected to a VoiceXML Server 180 such that a traveling member of the household could call from his cell phone 182 in through the cellar network 185. The VoiceXML server 180 communicates with the Mediabee web server 190 to fetch the necessary VoiceXML scripts to service user requests. To communicate with the Mediabee Desktop Server 130 running at home, Web server 190 communicates with Jabber server 192, which communicates with system 130 through the Jabber protocol
Scenario 7: The system of scenario 6, with the following exception. Instead of the household data being hosted in the system 130, household data is instead hosted on system 190.
Scenario 8: This is a variation of scenario 6 where household data is mirrored on each client system and automatically synchronized periodically.

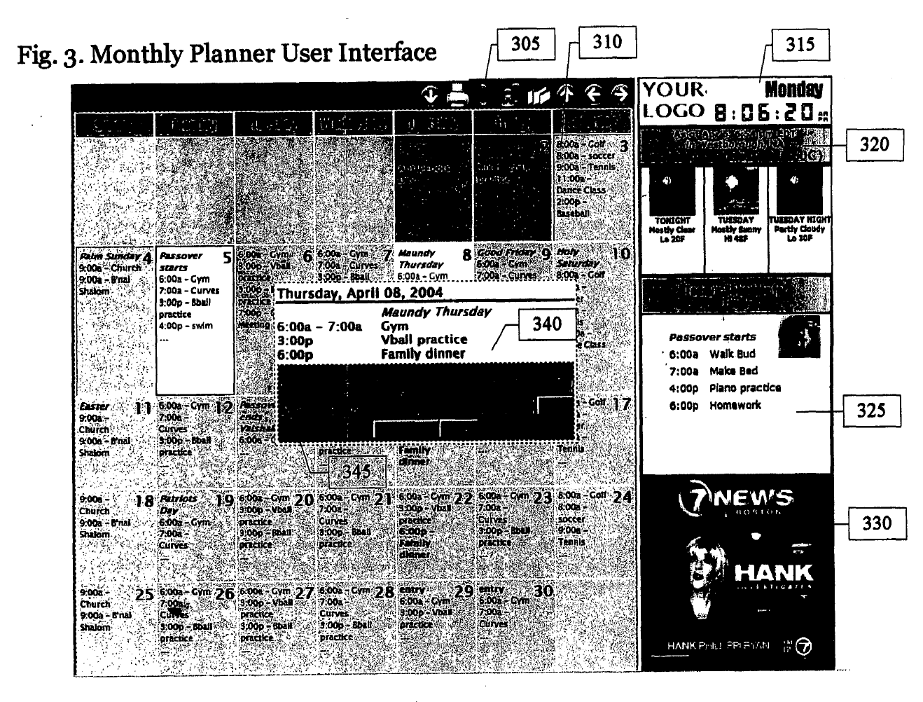

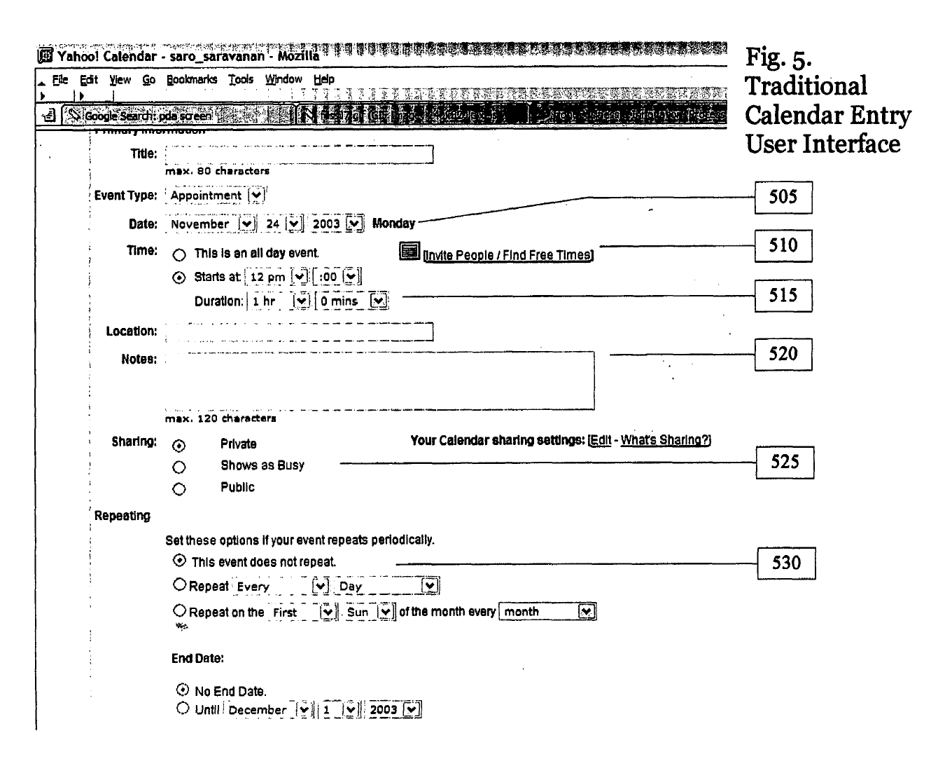

FIG. 3 shows one view of the Mediabee Client (see FIG. 2, item 205) user interface. The Mediabee Client typically embeds a browser, such as Microsoft Internet Explorer or Mozilla Firefox, and multiple “frames” within the browser to create a set of viewports. Each viewport covers one aspect of the user's information needs. In FIG. 3, item 305 is the application toolbar, which shows a few icons, in this case, the down arrow, printer, home, viewports, up arrow, left arrow, and right arrow icons. Item 310 shows the monthly calendar view, with entries for each group member who shares the calendar coded in a different color. Item 340 is the Monthly Calendar Popup Window, a key construct of the Mediabee Client. Item 345 is the Quick Add Entry Box. Items 340 and 345 are unusual constructs for computer-based calendaring programs. The typical calendar entry mechanism is as shown in FIG. 5, with a number of drop-down text boxes, radio buttons, and check boxes to allow the user to specify various aspects of a calendar entry.

One key innovation the Mediabee Desktop Client brings is a shorthand notation that takes fewer seconds and keystrokes to make entries. For example, “Soccer, 4-5 p, Mark” is a shorthand notation that Mark has a soccer appointment from 4 pm to 5 pm. This kind of shorthand notation is a basic building block to build a user-friendly multiplatform calendaring system such as the Mediabee application. The net effect of this notation is to dramatically reduce the amount of time it takes to make calendar entries whether you're trying to do it on your computer or through the limited keypad on your cell phone. A consequence of our implementation is that tools such as SMS and instant messaging can be used to update and share calendar-centric information freely between members of a trusted group, such as families and small businesses. Contrast this approach with that shown in FIG. 5.

In FIG. 3, Viewport 315 shows the day, date, and time and provides for branding messages from sponsors who pay for the privilege. Viewports 320, 325, and 330 are temporal information portals, i.e., they show different things at different times of day, according to the users' schedules and programming.

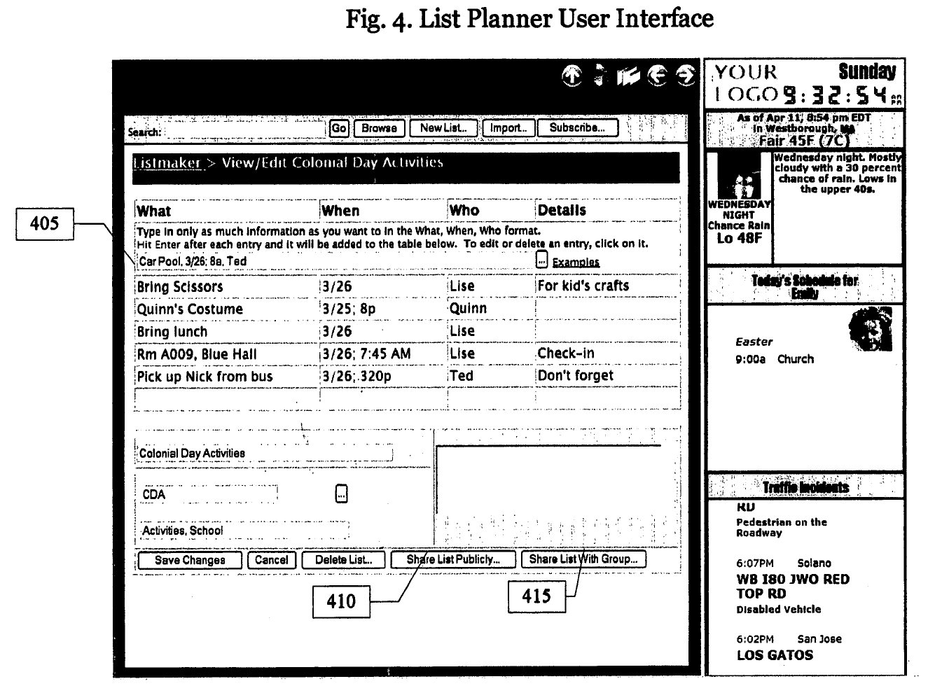

FIG. 4 shows the List Planner view of the Mediabee Client (see FIG. 2, item 205) user interface. The List Planner user interface brings simple delegation and project planning directly into the realm of everyday calendaring. In FIG. 4, item 405 is a simple to-do list created by the head of a household organizing his family for an event, “Colonial Day Activities”. The list shows how an action, “Bring Scissors”, is delegated to person “Lise”, who is a member of the household, and hence a member of the group calendar. By creating this list item, the user has automatically created a calendar entry for Lise. The List Planner is a great information sharing tool It can be used, for example, to quickly create a calendar of due dates for, say, school homework assignments, written in almost plain-English format (using the Mediabee shorthand notation), and then, using the buttons 410 or 415 in FIG. 4, shared either publicly or within a group of friends or neighbors. The act of sharing is further enhanced by the fact that users who subscribe to such a published calendar can choose to automatically get updates made by the publisher. One of the challenges in real life usage of communication tools such as email and websites for the purposes of communicating scheduling information is the fact that there is still an act required by the receiver of such communication to put said scheduling information into their calendar. By avoiding that step, our invention makes that process more automatic and the user's calendar more up-to-date and reliable.

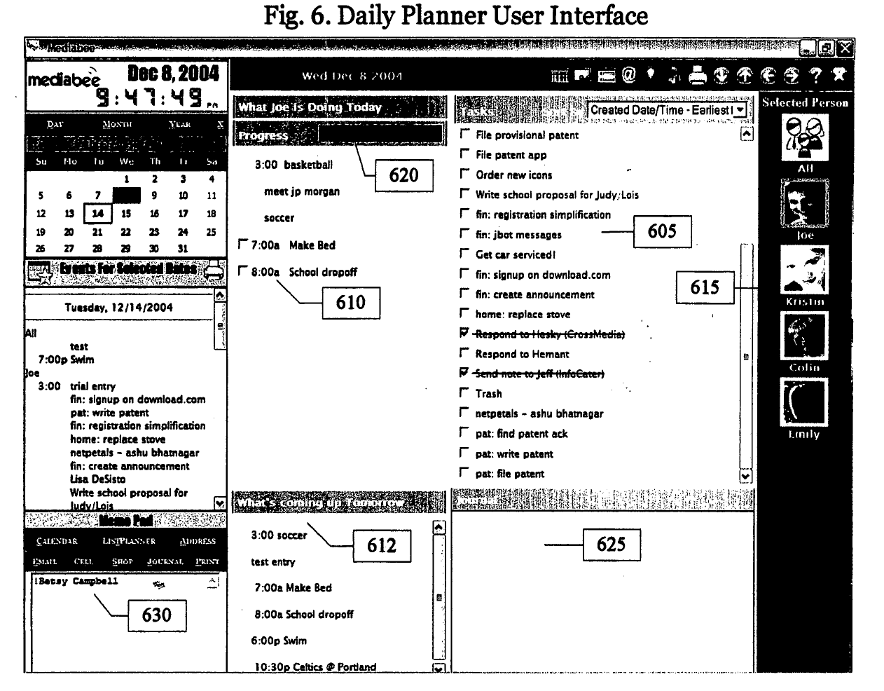

FIG. 6 shows the group Daily Planner user interface, which has separate display areas for today's appointments, chores, and notations under “What X is Doing Today” (610), tomorrow's appointments, chores, and notations under “What's Coming Up Tomorrow” (612), Ongoing Tasks (605), and Journal (625). A person selection area 615 shows pictures depicting each member of the group; clicking on the picture brings up that person's appointments, tasks, etc. Progress Meter 620 keeps track of how many tasks with check boxes have been completed, and hence checked off. Memo Pad 630 allows for entries to be made into the Day Planner, Monthly Planner, and other applications.

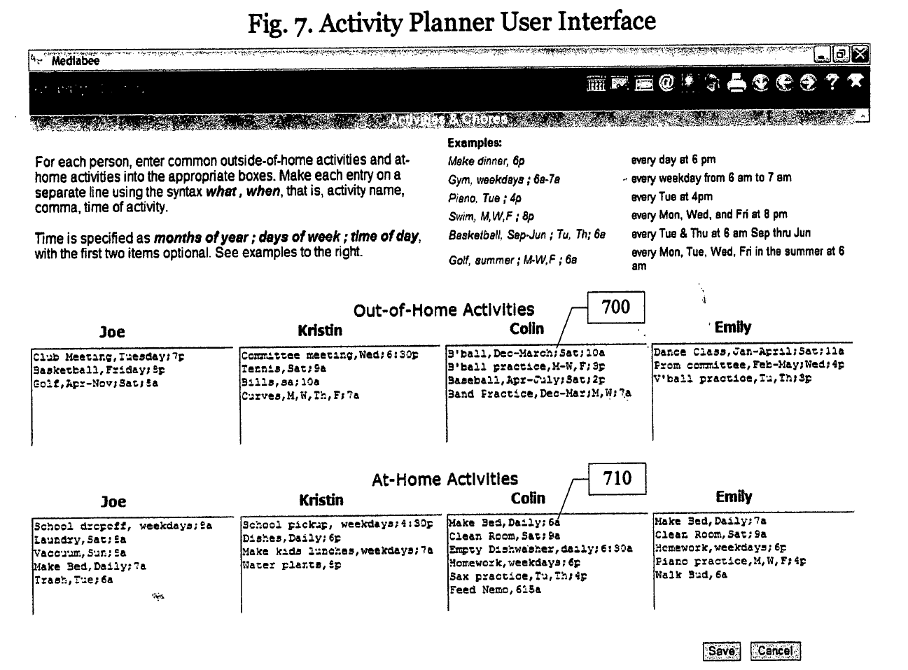

FIG. 7 shows the Activity Planner user interface, which provides one screen from which to plan all regular at-home and out-of-home activities for members of a household. With a traditional calendaring interface, this kind of planning would take several dialogs with the computer. Our shorthand method of creating entries makes it possible to plan in a new and unique way. People treat external commitments differently than internal commitments. The distinction between at-home and out-of-home activities makes it easy to mirror real-life needs. One distinction, for example, might be the association of email or cell phone reminders with activities. One would not typically care to get a cell phone reminder to feed the fish, whereas such a reminder for a dentist appointment would be valuable.

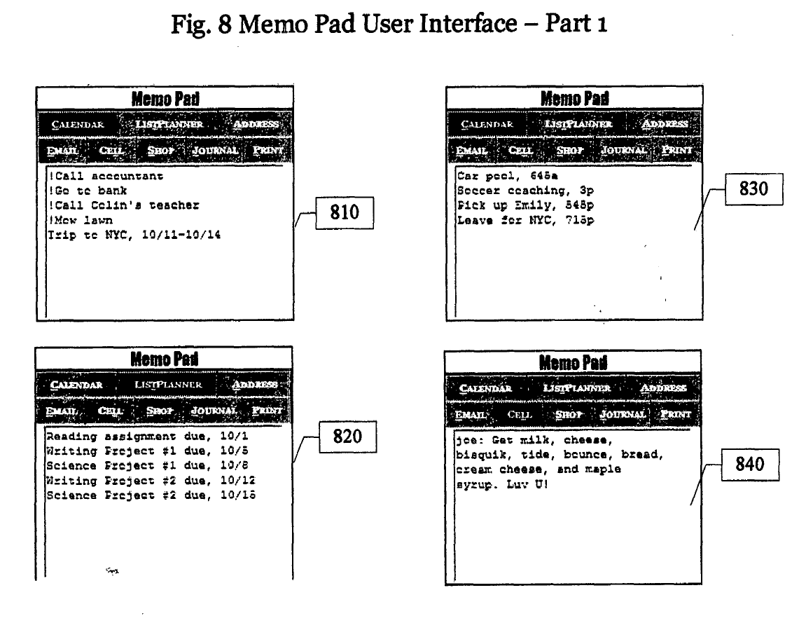

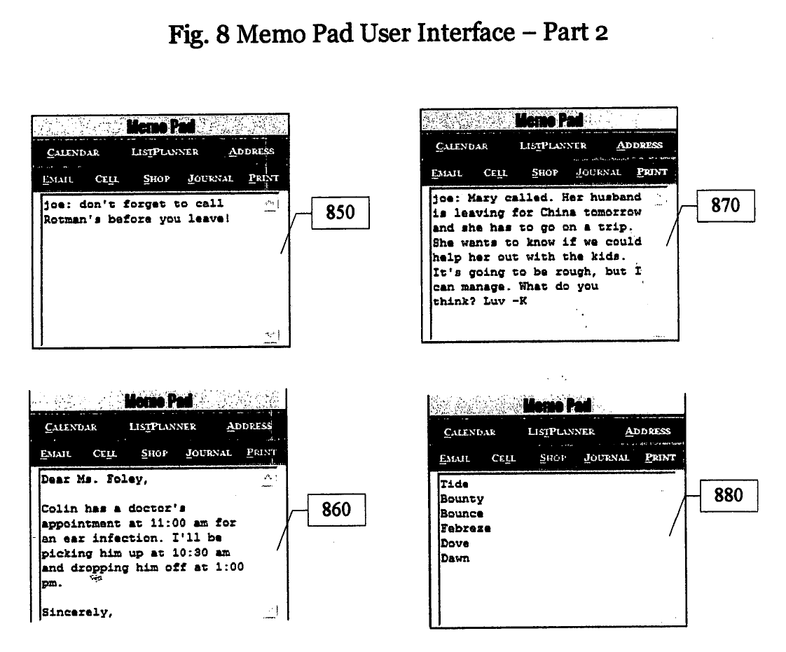

FIG. 8 is shown in two parts. Exhibit 810 through 880 show how the Memo Pad, which is always available for the end-user to access from a fixed part of the screen, can be used for a variety of different inputs to different applications using the same shorthand mechanism described in FIGS. 3 and 4 above. Exhibit 810 shows a number of “floating” tasks entered together with an event, “Trip to NYC, 10/11-10/14”. The button “Calendar” is highlighted because that is the button the user clicked to make the entries. The user can begin to enter the text into the Memo Pad and then decide what to do with the text by clicking on one of the buttons: “Calendar”, “ListPlanner”, “Address”, “Email”, “Cell”, “Shop”, “Journal”, and “Print”, depending on what the user wants to do. The set of buttons represents the choices commonly made in the environment in which the application is used. In the North American household, the buttons mentioned are probably the most commonly needed ones. There could be other buttons more suited to another situation, say a school or small business, where the application is used.

Exhibit 820 in FIG. 8 shows an assignment schedule being entered into the List Planner. The entries, which show the due dates of various assignments in plain English, could have been as easily entered directly into the Calendar as well. Creating a named list through the List Planner application makes it easier for the end-user to share those entries with anyone else who has a computer. Exhibit 830 in FIG. 8 shows a to-do list being created in the Calendar.

Exhibit 840 in FIG. 8 shows how a quick message can be sent to a cell phone using the same Memo Pad. The message reads “Joe: Get milk, cheese, bisquik, Tide, Bounce, bread, cream cheese, and maple syrup. Luv U!”. “Joe:” is a shorthand that is automatically recognized in the context of the “Cell” button as Joe's cell phone. Exhibit 850 shows how, likewise, a quick email message can be constructed and sent. In the context of the “Email” button, “Joe:” is recognized as Joe's email address.

Exhibit 860 in FIG. 8 shows a simple excuse note written to a school teacher. The message is sent to the printer through the “Print” button. Normally, a computer user would have to fire up a word processing application, such as Microsoft Word, type in the letter, and print it—a process that would take several times as long as the method shown in Exhibit 860.

Exhibit 870 in FIG. 8 shows a journal entry being made to Joe's diary. Any user of this multiperson application can write to any other user's journal. Exhibit 880 shows a shopping list being created and sent to the “Shop” application. The Shop application could transmit the list to a service such as Peapod, print a list of relevant coupons, or just send the list to a grocery store—whichever applies to the users situation.

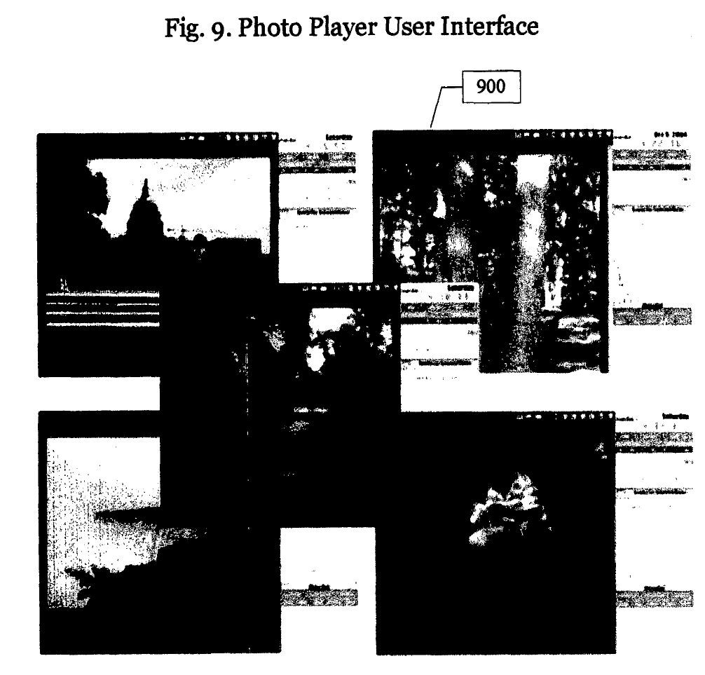

FIG. 9 shows the Photo Player user interface, captured at different points in time and superimposed to make a collage of screenshots. The Photo Player enhances the value of the family calendaring tool by increasing its chances of adoption. No content is more compelling than a family's own pictures. Digital camera users, who are also PC users, have started amassing literally hundreds of shoe boxes worth of digital photographs. The Mediabee application offers them a new way to experience, share, and organize their photographs—not as a standalone, special-purpose application, of which there are plenty, but as a part of an application they would use several times a day.

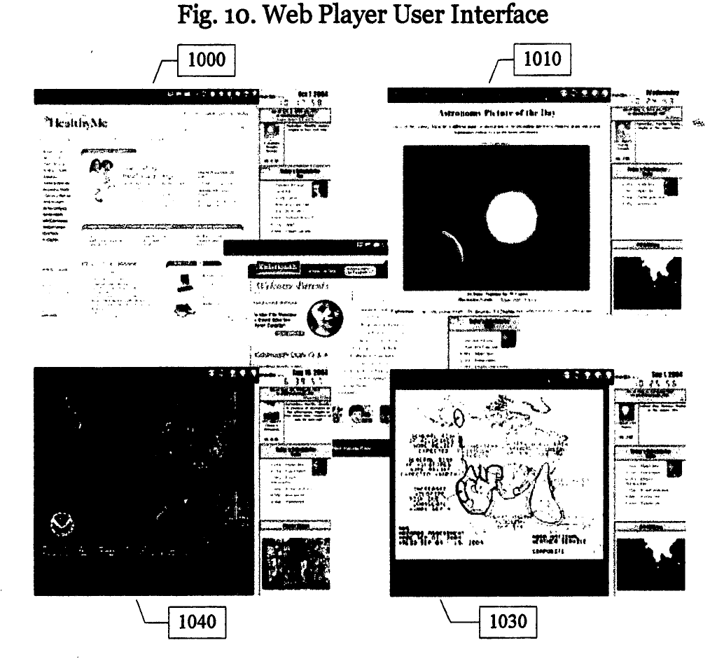

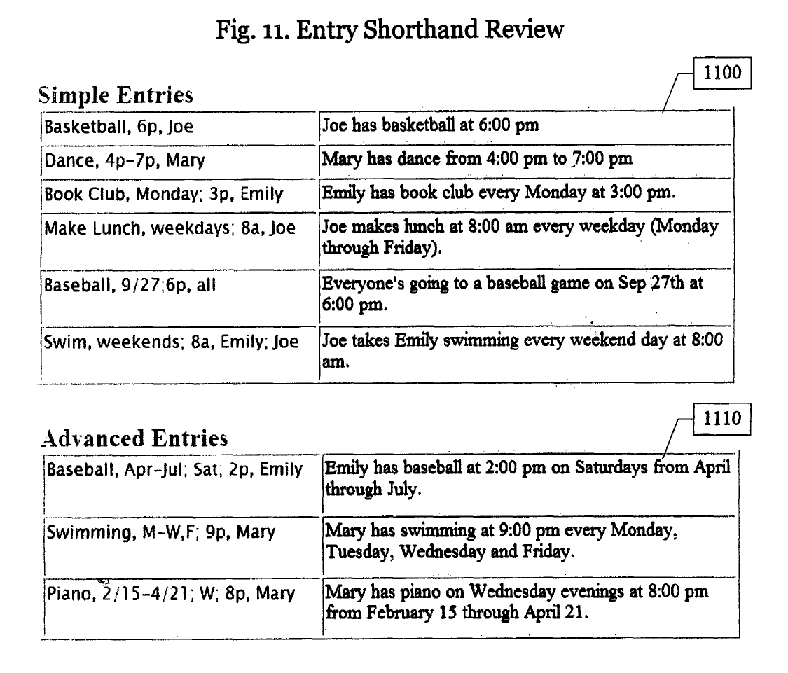

FIG. 10 shows the Web Player user interface, captured at different points in time and superimposed to make a collage of screenshots. The Web Player enhances the value of the family calendaring tool by increasing its chances of adoption. The Web Player within the Mediabee application offers users a new way to experience websites that provide educational and inspirational information, not as a standalone, special-purpose application, of which there are plenty, but as a part of an application they would use several times a day. Item 1000 shows a health-related website in the application's main panel. Item 1010 shows the National Aeronautics and Space Administration's Astronomy Picture of the Day website within the application's main panel. Items 1030 and 1040 show weather maps from the National Weather Service in the Mediabee application's main panel. The Web Player is capable of bringing up traditional websites, such as those you would conventionally open up using a browser, but also some applications that are built by Mediabee. In addition, the Rich Site Summary (RSS) format is supported.

Through careful consideration of all the factors influencing the utility, or lack thereof of computing devices for calendaring, and solving the related problems, the invention makes possible a number of benefits to consumers and companies that service them. They are outlined below:

1) Method for Simplifying the Creation and Management of Calendar Entries on Computers, PDAs, Cell Phones, and Other Devices that Requires Minimal Interaction. Method for Using Email, SMS, and Instant Messaging Tools to Simplify Household Information Management.

Calendaring software has been around for many years. The number and types of personal and group productivity applications are virtually limitless. Yet none have tackled one of the most basic problems with this class of software: that of adoption by the average user. A number of factors contribute to lack of adoption, but one of the most basic is that of how long it takes to make, edit, and delete entries on the calendar. Yahoo Calendar is currently one of the most popular calendar interfaces—a screen shot is shown in FIG. 6.

The calendar interfaces of Microsoft Outlook, MSN Calendar, and AOL Calendar are not too dissimilar. This is actually a daunting interface for most people, especially home users whose jobs don't depend on a mastery of this kind of interface. A personal digital assistant (PDA) device, like a Palm Pilot HandSpring Treo, or a Pocket PC phone/PDA combo device, has only a slightly less intimidating method of calendar entry. Between the stylus usage to select from dropdowns and writing on the “Graffiti” or other handwriting recognition device, making a calendar entry on these devices is considered a chore in itself by a majority of users [U. of Maryland Calendaring Study 2002].

The Mediabee approach to interaction with the calendar is vastly simplified. It is basically a shorthand notation that takes fewer seconds and keystrokes. For example, “Soccer, 4-5 p, Mark” is a shorthand notation that Mark has a soccer appointment from 4 P.M to 5 P.M. This kind of shorthand notation is a basic building block to building a user-friendly multiplatform calendaring system such as the Mediabee HIM. The net effect of this notation is to dramatically reduce the amount of time it takes to make calendar entries whether you're trying to do it on your computer or through the limited keypad on your cell phone. FIG. 11 shows examples of the entry shorthand that makes our system so simple to use.

Another consequence of this method, which avoids the traditional calendaring user interface in favor of a short text string, is that tools such as short message services (SMS) and instant messaging can be used to update and share calendar-centric information freely between members of a trusted group, such as families and small businesses. In cases such as SMS, depending on the device used and the availability of keys in the input device, for example, there may be some variations in syntax, but the spirit of making entries without the need for a great deal of interaction will be preserved.

2) Method for Using Lists to Organize Home and Business Information into Calendar Entries, Reminders, and Messages.

The List Planner user interface (FIG. 4) helps organize home and business information into list entries that turn automatically into calendar entries. The List Planner mimics the list-making behavior of people who are getting organized to accomplish something. A manager, for example, might create a set of to-dos for herself and each member of her group. On paper, this would be an easy task. With computer-based calendars, the task could be pretty complicated, involving a number of different steps such as acquiring permission to write to each person's calendar, selecting each person's calendar, making the appropriate entries, and in the end there would be no way to manage these activities from a central user interface. There are tools such as Microsoft Project that are specially designed for the purpose of delegating and monitoring tasks to a number of people, and such programs have calendars built into them, but such tools require a more sophisticated user, and they are typically not integrated into the calendars people use.

The Memo Pad (FIG. 8) is an alternative entry mechanism for the List Planner, and offers the same shorthand and ease-of-use.

3) Method for Creating and Monitoring Carryover Tasks and Progress Metering

Software such as Microsoft Outlook provides for the ability to create to-do lists. A to-do list item on such software typically has a task name, a due date, and priority as its properties. Tasks that are not checked off as having been completed by their due dates are marked in some manner—perhaps they appear in red or bold, for example. Such software typically makes no distinction between tasks that can be carried over and tasks that make no sense to carry over. If a task is a repetitive one that must be performed every day, for example, feeding the dog, it doesn't make sense to carry it over.

Contrast the conventional approach with the approach used in our Daily Planner user interface (FIG. 6). Our system allows for repetitive tasks to be tracked for completion (Exhibit 610 in FIG. 6). So, for example, feeding the dog, a daily chore, can be tracked easily because the system can automatically generate a daily to-do for feeding the dog, and allow the user to check it or not. If the user fails to check off the task, the task remains unchecked for that day, but the next day, a check box appears for the same task and could be checked off. Such a system is useful for tracking how well an individual is complying with every day responsibilities such as taking medication, cleaning the room, etc.

Our system allows for the metering of this progress on a real-time basis over daily, weekly, and monthly periods. This unique feature allows for incenting household members of small office workers to meet daily and weekly goals in addition to providing reminders and visual feedback on a daily basis. The combined tracking of all members of a household or business using the system will indicate the overall level of discipline, chaos, or stress in the household or business. A color-based visual indication or an incentive system can be combined with this tracking to improve discipline and reduce chaos and stress. This group rating could be combined with a device such as Ambient Devices' Orb product, centrally placed in a home or office setting, to indicate the level of stress in the home or office which would be directly related to the amount of regular activities or chores that have been ignored.

The same system also allows for certain tasks to be “carried over”. If your property taxes are due on June 15^{th}, for example, and you intended to pay it on June 1^{st}, you'd set up a reminder for yourself and choose the carryover option, specifying a deadline of June 15. From June 1 to June 15, as long as the item is not checked off for being completed, the system will provide visual and other feedback indicating that the task is imminently due and is in danger of being overdue. After June 15, the unchecked task will remain, but the system will stop complaining about it as the deadline is already past.

Over a period of time, if the system is used regularly, it can gradually change habits of people, making them more organized and less stressed. The key to making this work for people is to make it easy enough for people to adopt and maintain. The Activity Planner, a part of our invention, provides for an orderly way in which people can plan their regular at-home activities and regular out-of-home activities. FIG. 6 shows the Activity Planner.

4) Method for Using the System to Deliver Highly Relevant Information such as Traffic and Weather Updates, Flight Information, and so on in a Timely Manner Automatically

The Mediabee application setup and profile modules gather some key facts about the household or business situation under which it will be used. These modules are customizable to different environments—i.e., although the process is the same, the nature and types of questions asked may vary depending on the environment in which the application will be used. No matter what the environment, the goals of these modules are as follows:
Collect information about the various persons, places, and things that belong in the environment. For example, Mark and Mary live in Town X. They have two children, Nancy and Bob. Mark drives a 1999 Toyota Solara and Mary drives a 2001 Honda Odyssey. They have two pets: Princess, a cat, and Gizmo, a dog. Nancy is below school age and goes to day care.
Establish the routine temporal relationships between these objects including, for example, information about what major routes the user takes to work. For example, Mary lives in Westborough, works in Boston, and drops Nancy off in Wellesley on her way to work every morning. She works 8 to 4 Mondays through Thursdays and works at home on Fridays.
Establish other routines for the members of the group. For example, Mark plays golf every weekend morning from spring through summer. Bob takes out trash on Tuesday mornings at 6 am.

Between the information established through the setup process and the application setting and the information entered by the users into the calendar, a great deal is known about the home environment. This information can then be used to proactively bring information as needed into the application and various other implements used by family members. For example, just before Mary leaves for work, 7 to 8 am, traffic information for the routes relating to Mary's commute (including the detour to Nancy's daycare center) can be brought to the traffic, weather, and news panel of the application. The same information can be fed into a PDA or cell phone belonging to Mary or fed into the OnStar system in Mary's car.

Another example of this method is when Mark is on a trip, we bring information about things relating to his trip into the information panel of the application: Mark is in Cleveland today; Mark's flight to Chicago has been delayed by an hour; and so on.

5) Method for Scripting the Calendar to Drive the Scheduling of Content Display and Other System Operations

In the previous method, logic is embedded into the application to automatically schedule content for display. This method refers to user-programmability of that feature.

The List Planner has what, when, who, and options fields. List Planner entries are tightly integrated into the calendar and display scheduler, which provides for scheduling display items in various panels of our applications. Each viewport has a display list associated with it. For example, in the main window of our application, the upper right corner contains the clock panel. Just above the clock panel is a news and weather panel.

If you are an administrator of the system (its main user), you have the ability to modify the display lists of these panels. Through List Planner, you can select the System/Display/NewsWeatherPanel and add your own entries to the display list or modify the modifiable entries in that list. (Certain entries are maintained by the system and cannot be modified.) So, for example, just as you would specify “Floss, Daily; 8 p, All” in the List Planner, you could add “Traffic:commute, Daily; 8 a, Mark”. The only difference here is that the what typically would be a predefined keyword. The system provides a number of predefined keywords, but the users can add their own keywords through a scripting mechanism using a language such as Javascript.

What is unique about this is the simplicity with which this can be done, and the universal nature and applicability of our simplified shorthand for events.

6) Method for Annotating Digital Photographs Automatically Based on Information from the Calendar

The Mediabee application is a comprehensive but easy to use calendaring system Mediabee's focus is to drive adoption of the calendaring system so that many other benefits can be realized easily. One such benefit is the possibility of automatically annotating digital photographs.

Digital photographs are stored in the EXIF file format, which allows for, among other things, textual annotation of photographs. Some information, like when the photograph was taken, what the lighting conditions were, etc., is recorded by the digital camera that took the photograph Other information, like who's in the picture, is typically recorded by the photographer or other user using some external tool. Busy people often do not have time to carry out this step. Our software, if rigorously used by the family, contains a wealth of information about what was happening to whom at what times. For example, if Nancy has ballet practice at 6 P.M. on Monday, and some photographs were taken at that time, there is a very good chance that the photographs were those of Nancy in ballet practice.

One way in which this information could be used, for example, is as follows. The Photos section of Mediabee application provides an Auto-Annotate command, which, when invoked, would provide a table of photos with each photograph potentially corresponding to one or more calendar entries that occurred during or near the same time frame as when the photograph was recorded. This would allow the user to run this command and, perhaps in one quick sweep, accept all the auto-annotation as captions for the photos.

7) Method for using the System to Monitor Remote Events such as Children's Homework, Elders' Health & Medication, and Other Work-Life Balance Requirements

The capabilities of the Daily Planner user interface make it ideally suited for basic delivery of elder care services. Consider the following scenario. Your older parent wants to live alone despite your protestations; you're uncomfortable because you're living at a distance. He needs to take his medication three times a day and it could get serious if he misses his medication. You set up the Mediabee application on an inexpensive PC (or on a consumer device licensed to run Mediabee application) in his home similar to system 110 in FIG. 1. It reminds him of his medication 3 times a day requiring that he acknowledge doing so. You're in between meetings at your office when you notice that he didn't take his medication in the afternoon—so you call him. It turns out that he's not feeling well so you need to visit him.

Consider another scenario, as follows. You're in the office and your kids come back home from school. Your son is supposed to work on his science project and your daughter needs to practice her piano lessons. They both complete their work and check off the items on their schedules. In between meetings, you do a quick check and see that they're done with their homework. Your mind is at ease during that next meeting, and you didn't have to call to remind them.

8) Method for Improving Communication of Essential Messages Provided by Employees and Benefits Service Providers

The Photo Player (FIG. 9) and Web Player (FIG. 10) capabilities of the Mediabee application, combined with the ease-of-use in family calendaring, provide a great opportunity for employers seeking to improve the health and other well-being of their employees. The current methods used by employers and their benefits service providers are mostly traditional methods such as paper-based, email and intranet-based messages. These messages, while effective for pointed messages, such as requiring the employee to choose a primary care physician, for example, are not suited for repetitive long-term messaging that encourages employees to eat better, live a healthier lifestyle, and save more for retirement, for example.

The Mediabee application, if used by employees, would provide a great long-term messaging platform. The application in its current form, for example, includes a playlist of health-related websites such as http://www.kidshealth.org and http://ahealthyme.com. The application has a screen saver mode, in which, after a certain period of inactivity, the main application panel starts the web player. Employers and benefits providers could tailor the playlist to their communications needs, effectively improving long-term communications with employees, leading to happier, healthier, and presumably wealthier employees.

9) Method for Eliminating the Need for Paper Mail by Enabling the Delivery and Promotion of Electronic Catalogs, Coupons, and Other Messages using the System Without Compromising the Privacy of Users

Postal mail and newspaper delivery account for the lion's share of promotional materials coming into homes today, although email spam is very quickly overtaking paper based promotions in volume. A large amount of press materials testify to the fact that current email systems were simply not designed to balance the needs of marketers to get relevant promotional materials to willing prospects versus the ability of the consumer to choose when and what such information they want to process. The Mediabee application system is created from the ground up to allow for this balance.

A feature of our system is the ability of the user to make selections of the following nature:
Using the profile and lifestyle information kept by the system, automatically find relevant offers and present them to me. For example, if I select the pregnancy or birth life event checklist to add to my organizer, automatically find the appropriate offers and present them to me through the system.
Allow me to receive offers from certain vendors that I select
Allow me to receive offers of certain types
Show me offers related to the shopping list I input
Don't show me any offers for a certain period of time

Another feature is for these offers to automatically present reminders at selectable intervals.

10) Method for Managing the Display of Multiuser Calendaring and Repetitive Information to Present Information Within Certain Spatial Constraints.

Even the largest available displays and screen resolutions have spatial constraints when it comes to displaying calendar entries for a group of users that must be viewable from a nominal distance of 3-10 feet. Although we could design the display such that it is scrollable like any regular web page, that model would detract from our usability requirements, which closely model the wall calendar metaphor. One optimal model for operation of our application is that it will have the information that a user might require reachable through a minimal interaction, preferably no mouse or key clicks required. Our PC and Web clients use certain techniques that are uniquely optimized to display such information.

The following description applies to the monthly view of our calendaring application. Similar algorithms could be used to optimize the display for daily, weekly, and yearly views. If there are many entries on each date to show, we optimize the display to show more of the current information and less of information that's past or in the future. So let's say that there are 6 entries on each date. For the current week, show all the entries if possible. If there are more than X entries on any one day of the current week, show only X (say 10) entries with a . . . to indicate there are more. For previous and next weeks, show only Y (say 4) entries each with a . . . to indicate there are more. Show only up to Z (say 13) characters per entry to ensure that an entry doesn't exceed 1 row. This logic should also account for the “common user, display vs individual user display—i.e., when displaying entries for one person alone, there are bound to be fewer entries. X, Y, and Z are parameters of this parameter-driven system.

11) Method to Integrate Building Security and Automation Services into the System

Many homes today have services provided by security services companies such as ADT®. High-end systems have a great degree of sophistication in how the security system integrates with home automation and control systems that might be installed on premises. The vast majority of security installations are rather primitive in their knowledge of the premise residents' whereabouts.

Mediabee, through its simplicity of use, is able to capture a lot of information about the premise owners' habits and schedules. For example, the system is usually cognizant of when no one is expected to be in the premises or when adults may not be present in the household. Coupled with certain sensory systems, such as the recognition of a “bluetooth”—or global positioning satellite signal (GPS)—enabled cell phone on premises, Mediabee is able to provide a lot of information to a security system that can enable the security system to be “smart” about what kinds of actions to take upon a suspected security breach, even if the security system is not armed.

For example, a household might have a security system, but the owner may not have enabled it as she went to a soccer game with her child. During that time, the opening of a window is detected Mediabee knows that according to information that was entered into it, no one is supposed to be at home. So it alerts one or more of the adult occupants through an email and/or cell phone message (such as SMS) that something might be amiss. If the message recipient(s) do not respond within a predefined interval, Mediabee HIM might even alert the security company, depending on how the owner set up their preferences. The advantage of the Mediabee-enabled security system versus one that is not Mediabee-enabled is that there is an additional level of intelligence that can be applied by the system before deciding the course of action for notification. A traditional calendaring tool would be ineffective in this situation because it is highly unlikely to have the relevant information.

12) Method for Using the System to Script Various Security and Automation Tasks

Mediabee exposes its underlying objects using a simplified object model that can be programmed using a scripting language such as Javascript to adapt their premise security and automation system to the purposes of the user. A very simple example could be as follows: “If (Weather.Tate<45) HVAC.Heating.On.”

Manufacturers of various security and automation systems do provide some level of software programmability for their systems. However, there is no standard or system out there that accounts for household information management and calendaring objects comprehensively like the Mediabee system. How many members live in the household, how many are expected to be present in the premises at any given time, etc., are vital pieces of information for home automation and security functions; yet there is no system that supplies this information. This is a key advantage of the Mediabee system. By focusing on ease of use, driving adoption, and encouraging users to enter all pertinent scheduling information for household members into it, Mediabee creates good data inputs for the remaining systems.

The scripting feature exposes this data through simplified non-programmatic interfaces as well as programmatic ones in a manner that is well understood in the industry.

13) Method for Distributing Self-Organizing Content that is Purchased Through Micropayments.

Ringtones for cell phones are distributed on a micropayment basis by cell phone providers. Even though free tools exist for creating and uploading ringtones to cell phones have existed for years, what wireless carriers found is that users are willing to pay a premium for convenience and packaging of information. That is why the ringtones industry is a $1.5 B industry today and expected to be a $15 B/year industry in a few years.

The packaging of application and content around the Mediabee system, coupled with the Photo Player (FIG. 9) and the Web Player (FIG. 10), creates a similar opportunity to distribute specific types of content for which users will pay a convenience fee for access. Examples of such content include recipes, cartoons, photographs, posters, quotations, family memorabilia, genealogy, celebrity icons, reminder tones, etc.

What is claimed is:

1) A computer-based method for use in user interfaces for managing information, the method comprising:
based on a text-based shorthand and application context, receiving input of information;
based on the input, determining which of a plurality of group members should receive the information;
based on the input, determining whether an associated time is specified;
based on the input, if an associated time is specified, determining the timing and recurrence of the event;
based on the application context, members, occurrence time, and recurrence, storing a data object on a given computer system.

2) The method of claim 1, wherein the inputted information can indicate a task be shown on the calendar until it is checked off, rather than be associated with a single specific date and time range.

3) The method of claim 2, wherein the inputted information can be repeated multiple times to form a set of related entries that together make up a list.

4) The method of claim 3, wherein the list can be marked for sharing within a geographic area, such as a zipcode, state, region, or country.

5) The method of claim 4, wherein another computer user can view the shared lists for his or her geographic area and then choose to import or subscribe to the shared list.

6) The method of claim 5, wherein a user on another system, such as a remote work system, browser, email client, or cell phone, can remotely access the information using the same shorthand notation; such remote access could be for the purposes of among other things, remotely monitoring medication compliance of an elderly relative or remotely monitoring homework and chore completion of children.

7) The method of claim 6, wherein, based on the user-inputted information, other relevant information, such as news, weather, traffic, and sales bulletins can be automatically displayed to the user.

8) The method of claim 6, wherein user-inputted information can be coordinated with the time recorded in an electronic (digital) photograph, to automatically annotate the photograph with a corresponding event description.

9) The method of claim 6, wherein user-inputted information can be coordinated with the sensory inputs of a building security system to provide an additional level of intelligence and alertness to the inhabitants.

10) The method of claim 6, wherein user-inputted information can be coordinated with the controls of a building automation system to provide an additional level of automatic comfort to the inhabitants.
